(19) United States
(12) Patent Application Publication
(10) Pub. No.: US 2009/0301046 A1
(43) Pub. Date: Dec. 10, 2009

(54) FILTER ELEMENT WITH A 2-K FRAME

(75) Inventors: Uwe FELBER, Abtsteinach (DE); Ulrich STAHL, Laudenbach (DE); Claudio MARIN, St. Leon-Rot (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/479,936

(22) Filed: Jun. 8, 2009

(30) Foreign Application Priority Data
Jun. 10, 2008 (DE) 10 2008 027 507.7

(51) Int. Cl. B01D 29/33

(52) U.S. Cl. 55/502

(57) ABSTRACT

A filter element for use as an engine intake air filter, comprising a frame and a filter medium, wherein the frame at least partially surrounds the filter medium and wherein the frame comprises a sealing means that protrudes from the filter medium, is, with respect to the object of providing a filter element that exhibits a very high separation efficiency and is economically produced, characterized in that the frame is designed as a two-component part that comprises the sealing means and a seat for the filter medium.

### TECHNICAL AREA

The invention pertains to a filter element for use as an engine intake air filter, comprising a frame and a filter medium, wherein the frame at least partially surrounds the filter medium and wherein the frame comprises a sealing means that protrudes from the filter medium.

### PRIOR ART

Filter elements of the above type are already known from the prior art. Known in particular from the prior art is a frame made of plastic with a protruding flange. This flange serves as a seating means at a housing that holds the filter element.

However, the filter elements known from the prior art can only achieve separation efficiencies of about 96% according to DIN ISO 5011 due to the material properties of the frame.

However, in engine intake air filtration applications in particular, a separation efficiency of at least 99% is required. The known filter elements from the prior art cannot achieve these separation efficiencies.

### DESCRIPTION OF THE INVENTION

The object of the invention is therefore to provide a filter element for use as an engine intake air filter that exhibits a very high separation efficiency and can be produced economically.

The above object is achieved according to the invention through the features of patent claim 1.

Accordingly, the filter element for use as an engine intake air filter is characterized in that the frame is designed as a two-component part that comprises the sealing means and a seat for the filter element.

According to the invention, what has been found is that the design of the frame as a two-component part permits the frame to assume two functions. On the one hand, the frame can support the filter element with a sufficient degree of stability so as to avoid warping of the filter element upon the onset of pressure differences. On the other hand, the frame can be designed to deform or to be ductile in the area of the sealing means such that the sealing means seats against the wall of a housing without a problem, thereby providing a seal. According to the invention, what has been further found is that a two-component part made of plastic permits the entire filter element to be manufactured economically. Attaching a sealing means to a sufficiently non-warpable frame afterwards can be done away with.

The object described above is thus achieved.

With this in mind, the protruding sealing means could be made of a first component and the seat could be made of a second component, wherein the first component is designed to be softer than the second component. The components could be made of thermoplastic elastomers tailored to one another with regard to their softness. This specific embodiment makes it possible to design the seat to be hard and stiff such that the filter medium is supported by the seat in a stabile manner. Also, upon incident pressure differences between the upstream side and the downstream side, the filter medium is not warped or bent. This prevents the formation of gaps or cracks. The use of a softer component for the sealing means makes it possible to design the sealing means to be soft enough to cling against the wall of a housing for the filter element without a problem, thereby providing a seal. This also prevents the formation of cracks or gaps upon incident pressure differences. In engine intake air filtration, pressure differences of up to 40 millibars can occur between the upstream side and the downstream side. By using two different hard and soft components, separation efficiencies of at least 99% according to DIN ISO 5011 can be achieved at this pressure difference.

The sealing means could be designed as a sealing collar that surrounds the perimeter of the filter medium. This specific embodiment permits a reliable seal of the upstream side from the downstream side. A sealing collar can be designed in any arbitrary geometric shape.

A notch could be made in the sealing collar. This specific embodiment makes it possible to position another sealant in the notch. Moreover, the notch can be placed onto a protruding edge of the wall of a housing, similar to a tongue and groove joint. This further improves the sealing effect.

With this in mind, it is conceivable that the sealing means is designed as a sealing lip that surrounds the perimeter of the filter medium. This specific embodiment permits the sealing lip to be designed to protrude in the shape of a V such that it is pressed against the wall of a housing by an impinging fluid.

The filter medium could be glued to the frame. In the process, a polyurethane adhesive could be used. Gluing the filter medium to the frame permits gaps or cracks to be prevented between the frame and the filter medium.

With this in mind, it is likewise conceivable that the frame is molded onto the filter medium. Gaps and cracks between the frame and the filter medium can be prevented through this specific embodiment as well. Moreover, this concrete embodiment allows for a rapid manufacturing process, namely a two-component injection molding process.

The filter medium could be designed as a bellows made of a non-woven fabric. The use of a bellows permits the effective filter area to be increased. With this in mind, it is specifically conceivable for the filter medium to be designed as a so-called flat filter. Non-woven fabrics are sufficient for use with respect to their porosity and separation efficiency. Moreover, non-woven fabrics can be made of plastics and are therefore resistant to moisture.

The frame could comprise an hold-down strip that engages with the filter medium. This specific embodiment makes it possible for the hold-down strip to run along the walls of two folds and thus stabilize the ends of the filter medium.

Moreover, relatively fine and thin fold walls can be used since they are supported on one side by the seat of the frame and on the other side by the hold-down strip.

The frame could be manufactured from thermoplastic elastomers. Through this specific embodiment, the frame can be configured as a two-component injection molded part.

There are different ways to implement and expand on the teaching of the present invention in advantageous ways. In this regard, reference is made on the one hand to the dependent claims, on the other hand to the following description of a preferred exemplary embodiment of the invention with the aid of the drawing.

In connection with the description of the preferred exemplary embodiment of the invention with the aid of the drawing, preferred embodiments and further expansions of the teaching of the invention are described in general as well.

### SHORT DESCRIPTION OF THE DRAWING

Shown in the drawing are

FIG. 1: A perspective depiction of the filter element in a view of the upstream side,

FIG. 2: A perspective view of the filter element in a view of the downstream side,

FIG. 3: A top view of the filter element,

FIG. 4: A sectional view of the filter element according to FIG. 3 along line A-A,

FIG. 5: A sectional view of the frame according to FIG. 3 along line A-A,

FIG. 6: A sectional view of the filter element along line B-B of FIG. 3 and

FIG. 7: A sectional view of an area of the frame that is identified in FIG. 6 with a circle.

### EMBODIMENT OF THE INVENTION

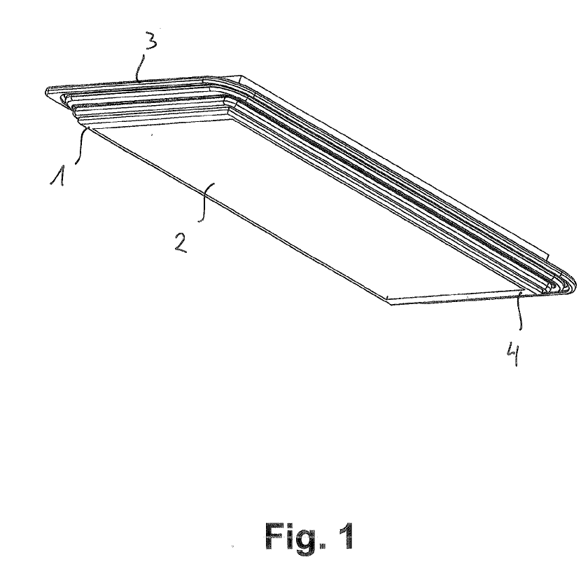

FIG. 1 shows a perspective view of a filter element used as an engine intake air filter. This filter element comprises a frame 1 that completely surrounds a filter medium 2, wherein the frame 1 comprises a sealing means 3 that protrudes from the filter medium 2. The frame 1 is designed as a two-component part made of plastic, comprising the sealing means 3 and a seat 4 for the filter medium 2. FIG. 1 shows a view of the upstream side of the filter element.

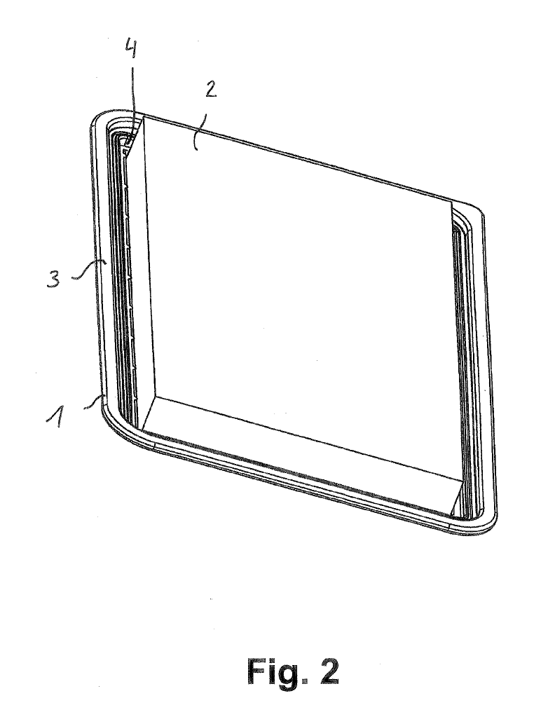

FIG. 2 shows a perspective view of the filter element according to FIG. 1 in a view of the downstream side of the filter medium 2. From FIG. 2, one can see that the filter medium 2, which is designed as a bellows made of a non-woven fabric, is securely connected to the frame 1. The frame 1 comprises a sealing means 3 and a seat 4.

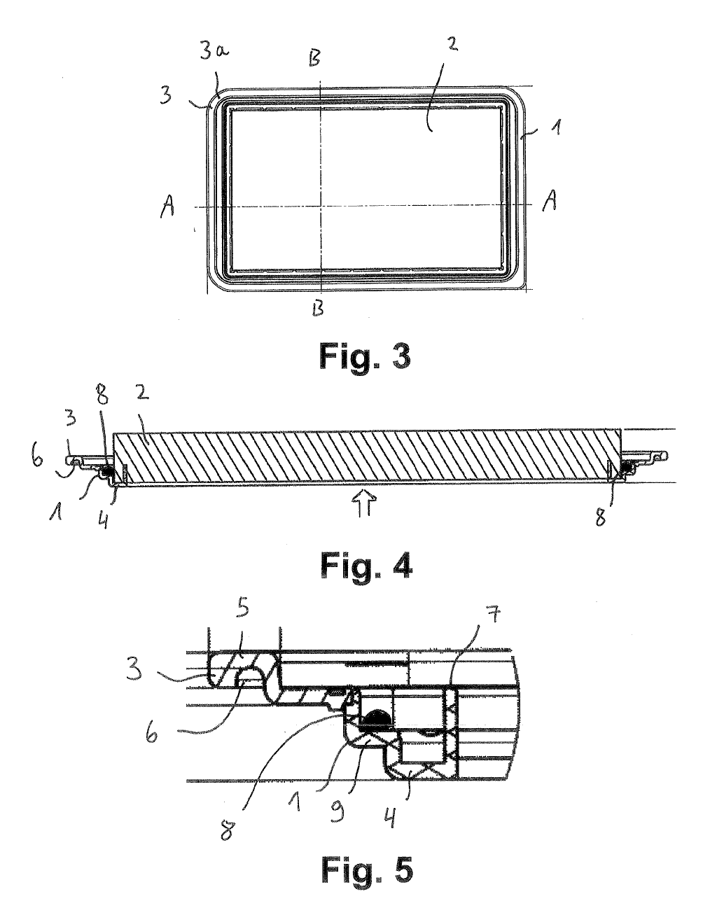

FIG. 3 shows a view of the filter element according to FIG. 1 and FIG. 2 in a view of the downstream side. In FIG. 3, one can see that the frame 1 completely surrounds the perimeter of the filter medium 2. The frame 1 comprises a sealing means 3 that has rounded areas 3a. The rounded areas 3a allow the sealing means to seat at a wall (not shown) without the formation of folds, gaps or cracks through which a fluid to be filtered can pass without being filtered.

FIG. 4 shows a sectional view of the filter element according to FIG. 1 through 3 along line A-A according to FIG. 3. The frame 1 is designed as a two-component part, comprising the sealing means 3 and the seat 4 for the filter medium 2. The protruding sealing means 3 is made of a first component and the seat 4 is made of a second component, wherein the first component is designed to be softer than the second component. This makes it possible for the sealing means 3 to deformably cling to a wall of a housing for the filter element and thus reliably seal. The seat 4 is designed to be hard such that upon the incidence of a pressure difference between the upstream side and the downstream side of the filter element, warping or deformation of the filter medium 2 is largely prevented. In FIG. 4, the arrow indicates the direction of flow of the air to be filtered, which penetrates the upstream side and exits the downstream side.

The sealing means 3 is designed as a sealing collar 5 that surrounds the perimeter of the filter medium 2. A notch 6 is formed in the sealing collar 5 into which another sealant can be placed. However, it is conceivable that an element of the wall of a housing, being designed complementary to the notch 6, can be held in the notch 6. This could be implemented similar to a tongue and groove joint, for example.

FIG. 5 shows in detail in a sectional view the area of the frame that is shown in FIG. 4 in a sectional view. FIG. 5 shows in particular the notch 6 that is designed in the sealing collar 5. Moreover, from FIG. 5 it can be seen that the frame 1 is designed as a two-component part, wherein one component is used to make the seat 4 and another component is used to make the protruding sealing means 3. In FIG. 5, one can see that the frame 1 comprises a hold-down strip 7. The hold-down strip 7 can extend in between the walls of two folds of the filter medium 2 and thus additionally stabilize the filter medium. Also shown in FIG. 5 is a adhesive track 8 that makes a form-fitted joint with the filter medium 2 to achieve a reliable seal. The adhesive track 8 ensures that no cracks or gaps arise between the filter medium 2 and the frame 1 that could negatively affect the separation efficiency.

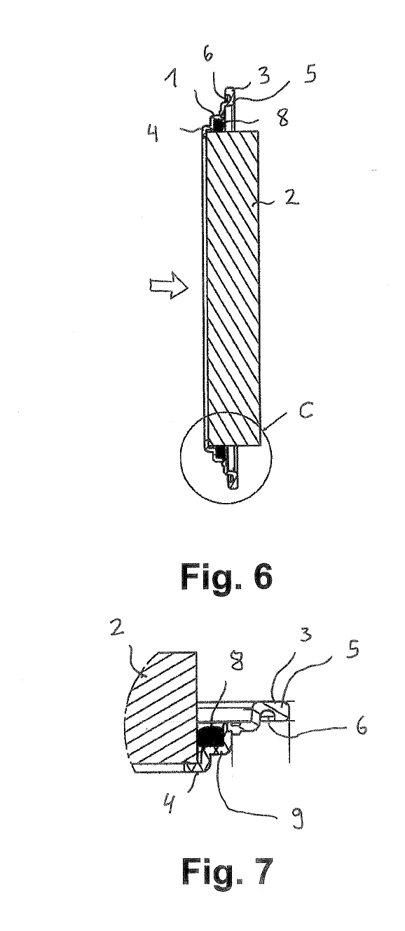

FIG. 6 shows the filter element according to FIG. 1 through 3 in a side view along line B-B according to FIG. 3. One can see from FIG. 6 as well that the frame 1 is provided with a protruding sealing means 3 designed as a perimeter collar 5. The frame 1 also comprises a seat 4 against which the filter medium 2 sits. An adhesive track makes a form-fitted joint with the filter medium 2. Also seen in FIG. 6 is that the sealing collar 5 is provided with a notch 6. In FIG. 6, the arrow indicates the direction of flow of the air to be filtered, which penetrates the upstream side and exits the downstream side.

FIG. 7 shows the area of frame 1 marked as C in FIG. 6. In FIG. 7, one can see that the frame 1 is designed as a two-component part. Here, the frame 1 comprises a seat 4 and a protruding sealing means 3 that is designed as a perimeter sealing collar 5 with a notch 6. An adhesive track 8 produces a form-fitted joint with the filter medium 2.

The adhesive track is placed on a stepped ledge 9 of the seat. The adhesive track 8 can consist of a polyurethane adhesive in the exemplary embodiment shown here.

The frame 1 could be manufactured from thermoplastic elastomers.

Regarding further advantageous embodiments and developments of the teaching according to the invention, reference is made on one hand to the general portion of the description and on the other hand to the patent claims.

Finally, it is expressly emphasized that the above exemplary embodiment, which was selected purely arbitrarily, is only for purposes of explanation of the teaching of the invention and does not limit this teaching to this exemplary embodiment.

What is claimed is:

1. A filter element for use as an engine intake air filter, comprising a frame and a filter medium, wherein the frame at least partially surrounds the filter medium and wherein the frame comprises a sealing means that protrudes from the filter medium, wherein the frame is designed as a two-component part that comprises the sealing means and a seat for the filter medium

2. A filter element according to claim 1, wherein the protruding sealing means is made of a first component and the seat is made of a second component, wherein the first component is designed to be softer than the second component.

3. A filter element according to claim 1, wherein the sealing means is designed a sealing collar that surrounds the perimeter of the filter medium.

4. A filter element according to claim 3, wherein a notch +is designed in the sealing collar.

5. A filter element according to claim 1, wherein the sealing means is designed a sealing lip that surrounds the perimeter of the filter medium.

6. A filter element according to claim 1, wherein the filter medium is glued to the frame.

7. A filter element according to claim 1, the frame is molded to the filter medium.

8. A filter element according to claim 1, wherein the filter medium is designed as a flat filter with a bellows made of a non-woven fabric.

9. A filter element according to claim 1, wherein the frame comprises a hold-down strip that engages the filter medium.

10. A filter element according to claim 1, wherein the frame is made of thermoplastic elastomers.
